(19) United States
(12) Patent Application Publication
(10) Pub. No.: US 2019/0021281 A1
(43) Pub. Date: Jan. 24, 2019

(54) Animal Garment

(71) Applicant: Kenneth Fultz, Modesto, CA (US)

(72) Inventor: Kenneth Fultz, Modesto, CA (US)

(21) Appl. No.: 15/964,953

(22) Filed: Apr. 27, 2018

Related U.S. Application Data
(60) Provisional application No. 62/534,769, filed on Jul. 20, 2017.

(51) Int. Cl. A01K 13/00; A01K 27/00

(52) U.S. Cl. CPC A01K 13/006; A01K 27/002; A01K 27/003

(57) ABSTRACT

An animal garment. The animal garment includes a body having a front opening, a rear opening, and a pair of leg openings, wherein the front opening can receive a head of an animal therethrough and the pair of leg openings can each receive front leg of an animal therethrough. The pair of leg openings are disposed on a lower side of the body adjacent to the front opening. A pocket is disposed on an upper side of the body, wherein the pocket can be secured in a closed position via a fastener. The garment further includes a leash affixed to the body at the pocket. The pocket can receive the leash therein for storage when the leash is not in use.

### CROSS REFERENCE TO RELATED APPLICATIONS

This application claims the benefit of U.S. Provisional Application No. 62/534,769 filed on Jul. 20, 2017. The above identified patent application is herein incorporated by reference in its entirety to provide continuity of disclosure

### BACKGROUND OF THE INVENTION

The present invention relates to animal garments. Specifically, the present invention relates to animal garments having a pocket secured by a fastener thereon, wherein a leash is to the animal garment.

Many people own pets that need to be taken for walks, however frequently local weather conditions may cause an animal to require additional layers for warmth. Additionally, health conditions may require an animal to cover up certain areas to prevent the animal from interacting with the area. While clothed for warmth or protection, it can be difficult and frustrating to put a collar or harness on an animal to attach a leash to for walking purposes. Devices in the known art provide various garments to provide warmth and comfort, or harnesses with additional storage options, however there is a need for a device that can operate as a comfortable harness over extended periods, while also providing warmth to the animal. Therefore, an animal garment that can provide warmth and comfort while acting as a harness having a pocket that can store a leash therein and having the leash affixed thereto is desired.

In light of the devices disclosed in the known art, it is submitted that the present invention substantially diverges in design elements from the known art and consequently it is clear that there is a need in the art for an improvement to existing animal garments. In this regard, the instant invention substantially fulfills these needs.

### SUMMARY OF THE INVENTION

In view of the foregoing disadvantages inherent in the known types of animal garments now present in the prior art, the present invention provides an animal garment wherein the same can be utilized for providing convenience for the user when walking an animal on a leash while the animal is wearing a garment.

The present system comprises a body having a front opening, a rear opening, and a pair of leg openings, wherein the front opening is configured to receive a head of an animal therethrough, and the pair of leg openings area each configured to receive a front leg of the animal therethrough. The pair of leg openings are disposed on a lower side of the body adjacent to the front opening. A pocket is disposed on an upper side of the body, wherein the pocket is configured to secure in a closed position via a fastener. A leash is configured to store within the pocket when not in use. The leash is affixed to the body at the pocket. In some embodiments, the body further comprises a harness disposed therein, between an inner layer of material and an outer layer of material. In another embodiment, a U-shaped cutout is disposed on the lower side adjacent to the rear opening, wherein the U-shaped cutout is configured to expose an underside of the animal. In other embodiments, a second end of the leash further comprises a loop configured to receive a hand therethrough. In yet another embodiment, the body comprises an insulated material configured to retain body heat of the animal. In some embodiments, the insulated material comprises crocheted yarn.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the animal garment.

FIG. 2 shows a lower view of an embodiment of the animal garment.

FIG. 3 shows a perspective view of the leash of an embodiment of the animal garment.

FIG. 4 shows a transparent view of the pocket having a leash therein of an embodiment of the animal garment.

FIG. 5 shows a perspective view of an embodiment of the animal garment in use.

### DETAILED DESCRIPTION OF THE INVENTION

Reference is made herein to the attached drawings. Like reference numerals are used throughout the drawings to depict like or similar elements of the animal garment as configured for a dog, however alternate embodiments designed for various other domesticated animals are contemplated. The figures are intended for representative purposes only and should not be considered to be limiting in any respect.

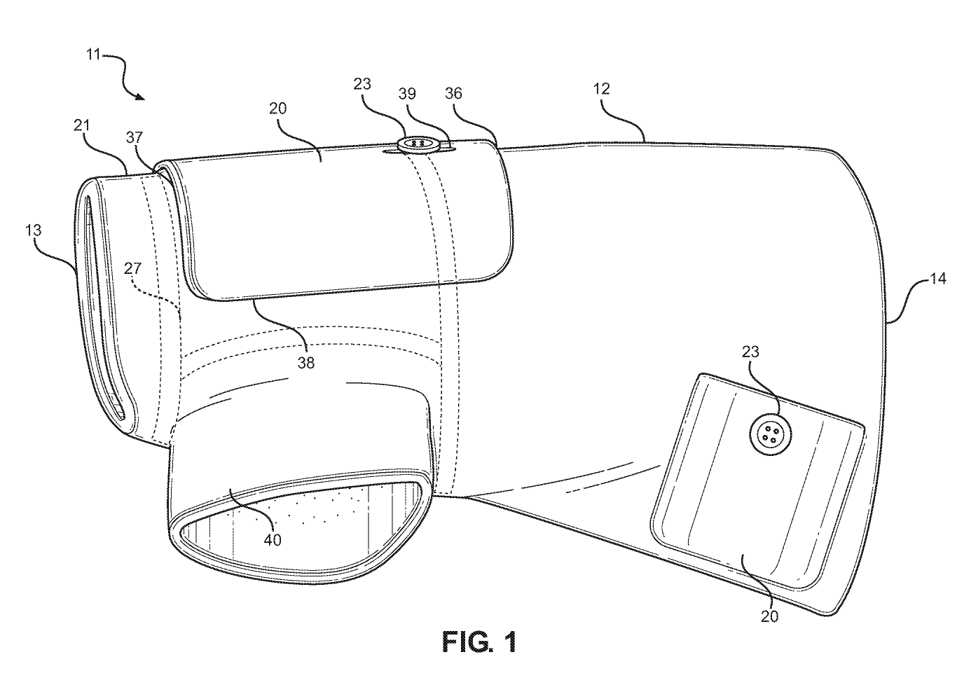

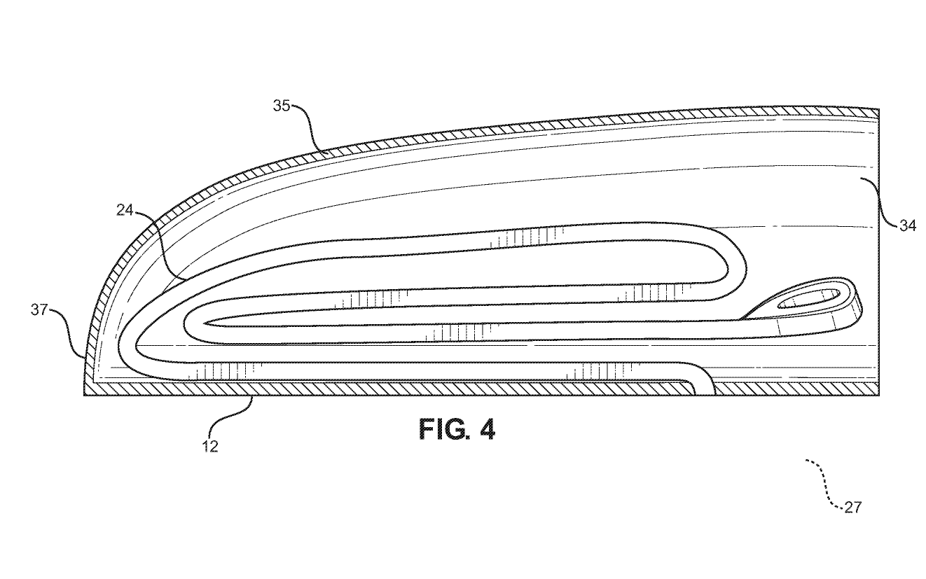

Referring now to FIGS. 1 and 4, there is shown a perspective view of an embodiment of the animal garment and a transparent view of the pocket having a leash therein of an embodiment of the animal garment, respectively. The animal garment 11 comprises a body 12 having a front opening 13 and a rear opening 14. The front opening 13 is configured to receive a head of an animal therethrough, and the rear opening 14 is configured to receive a rear portion of the animal therethrough. In this way, the body 12 is configured to wrap about the animal from a neck thereof, to the rear portion thereof, so as to provide comfort and warmth to the animal. In the illustrated embodiment, the animal garment 11 comprises a thermally insulated material configured to retain body heat produced by the animal. In an alternate embodiment, the animal garment 11 is composed of crocheted yarn, wherein the yarn is configured to simultaneously retain the body heat of the animal and provide comfort to the animal.

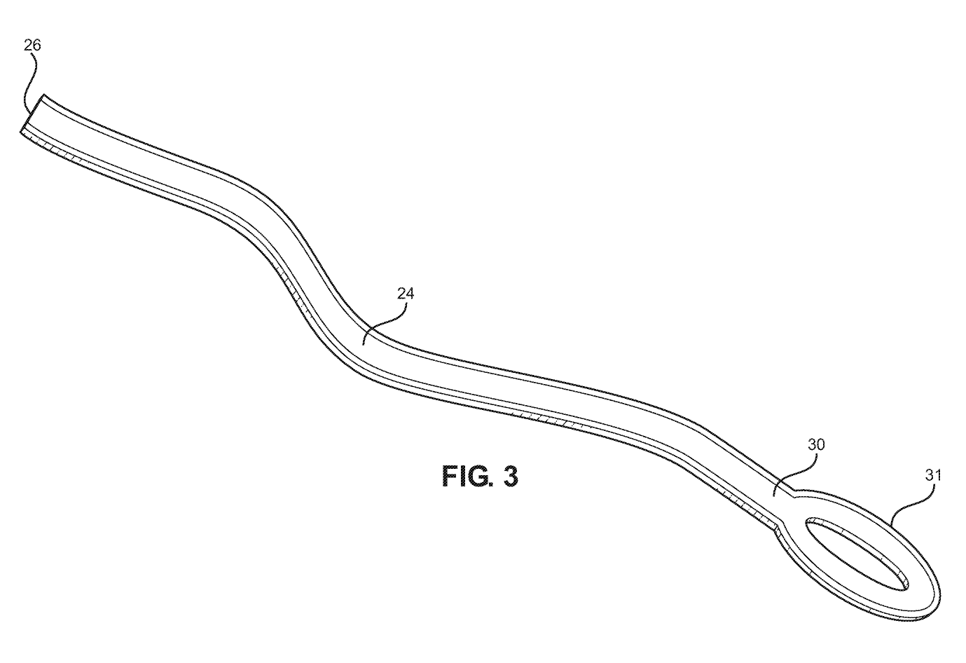

The animal garment 11 further comprises a pocket 20 disposed on an upper side 21 of the body 12. In the illustrated embodiment, the pocket 20 is disposed on the upper side 21 such that the pocket 20 would rest between each shoulder of the animal when the animal garment 11 is in use. The pocket 20 comprises an interior volume 34 defined by a pair of lateral of sides 38 and a base 37, wherein the pair of lateral sides 38 and the base 37 are affixed to the body 12. An opening 36 provides access to the interior volume 34. The interior volume 34 is formed between a sidewall 35 and the body 12. In the illustrated embodiment, the opening 36 is shown facing towards the rear opening 14, however, in alternate embodiments, the opening 36 faces towards the front opening 13. In the shown embodiment, the pocket 20 is centrally located along the upper side 21, however in alternate embodiments, the pocket 20 can be located elsewhere along the body. The pocket 20 further comprises a slit 39 therein adjacent to the opening 36, the slit 39 configured to receive a fastener 23 therethrough, thereby securing the pocket 20 in a closed position, such that the contents of the pocket 20 remain within the interior volume of the pocket 20. A leash (shown in FIG. 3, 24) is configured to removably store within the pocket 20, so as to provide convenience to the user when walking the animal. In this way, the user can securely store a leash or other object in the pocket 20 to be retrieved therefrom when desired. Additionally, when the leash is in use, the pocket 20 can be used to store a variety of other objects, such as pet waste collection bags. In an alternate embodiment, the animal garment 11 further comprises additional pockets 20 disposed along the body 12, such as a pair of opposing pockets 20 disposed on opposing sides of the body 12 adjacent to the rear opening 14. In some embodiments, the animal garment 11 further comprises a hood disposed adjacent to the opening of the pocket 20, such that the hood can be folded into the pocket 20. The hood is configured to extend over the head of the animal, such that the hood covers an upper portion of the head. In this way, the user can remove the hood from the pocket 20 to deploy the hood over the head of the animal, thereby providing warmth, comfort, and protection to the head of the animal.

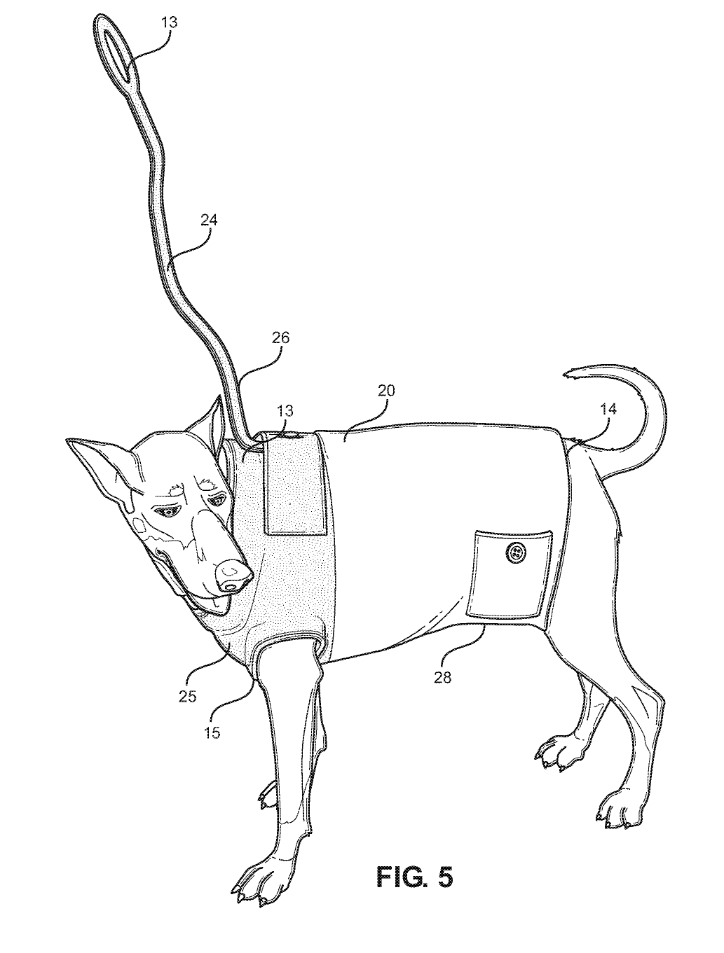

In the illustrated embodiment, the animal garment 11 further comprises a harness 27 disposed within the body 12. The harness 27 can be secured within the body 12 by intertwining nylon cord, or other suitably durable material, with the material of the body 12, such that the harness 27 is formed thereby. The harness 27 is configured to wrap around a chest, legs, back, waist, and torso of the animal wearing the animal garment 11, such that any forces applied to the harness 27 are evenly distributed across the animal. In this way, the animal garment 11 can prevent injury to the animal due to sudden forces caused by a user pulling back on the leash. In the illustrated embodiment, the harness 27 is integral with the body 12 and the fastener 23, such that any forces applied through the fastener 23 are distributed through the harness 27 rather than the body 12. In this way, the harness 27 adds structural integrity to the body 12, minimizing the risk of any damage to the body 12 caused by sudden forces. In the illustrated embodiment of FIG. 5, a front portion 25 of the body 12 comprises material strengthened by additional material, such as nylon, intertwined with the base material of the body. In this way, the strengthened front portion 25 acts as another form of integral harness 27, spreading force evenly across the animal and preventing damage to the animal garment 11 due to forces exerted thereon.

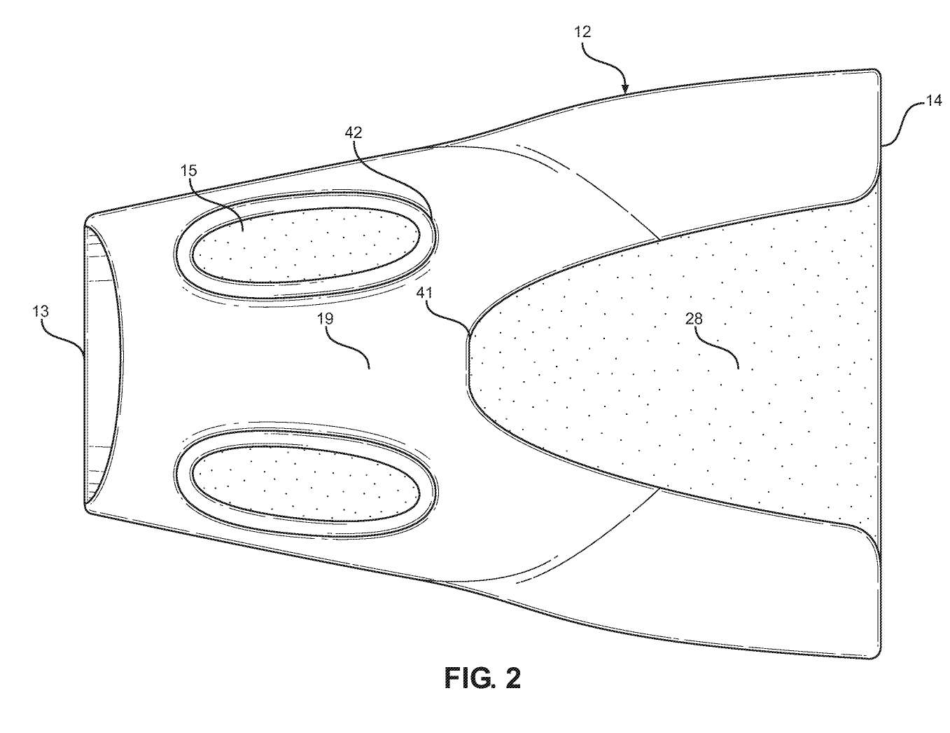

Referring now to FIG. 2, there is shown a lower view of an embodiment of the animal garment. The animal garment further comprises a pair of leg openings 15 disposed on a lower side 19 of the body 12. The pair of leg openings 15 are disposed adjacent to the front opening 13, such that the pair of leg openings 15 are each configured to receive a front leg of the animal therethrough. In this way, the animal garment can secure to animal such that the body 12 is prevented from rotating about the animal. In some embodiments, the pair of leg openings 15 further comprise an elastic material, wherein the pair of leg openings 15 are configured to constrict about the front legs of an animal. In this way, pair of leg openings 15 can removably secure about the legs of the animal, such that the pair of leg openings 15 remain stationary along the legs of the animal during use. As shown in the illustrated embodiment of FIG. 1, the pair of leg openings 15 further comprise a sleeve (as shown in FIG. 1, 40) extending perpendicularly away from the lower side 19 of the body 12, wherein the sleeve is configured to encompass a section of the front legs of the animal, so as to provide greater warmth and comfort thereto. In the illustrated embodiment, the sleeve is configured to extend along a front leg of the animal towards an elbow of the front legs, however alternate sleeve lengths are also contemplated.

In the illustrated embodiment, the animal garment further comprises a U-shaped cutout 28 disposed on the lower side 19 adjacent to the rear opening 14. The U-shaped cutout 28 extends along the lower side 19 from the rear opening 14 such that the U-shaped cutout 28 is configured to expose an underside of the animal. In this way, the animal can perform bodily functions without soiling the animal garment, and without requiring the removal of the animal garment. In the illustrated embodiment, the U-shaped cutout 28 extends towards the front opening 13 such that an upper end 41 of the U-shaped cutout 28 aligns with a lower end 42 of the pair of leg openings 15. In the shown embodiment, the U-shaped cutout 28 is disposed centrally on the lower side 19, such that the upper end 41 rests between the pair of leg openings 15.

Referring now to FIG. 3, there is shown a perspective view of the leash of an embodiment of the animal garment. The animal garment further comprises a leash 24 configured to removably store within the pocket of the animal garment. In the illustrated embodiment, the leash 24 is integral with the garment, such that the first end 26 of the leash 24 is permanently affixed to the garment at the pocket, wherein the first end 26 is disposed within the pocket. In this way, the garment can be used as a leash and harness system simultaneously. In the illustrated embodiment, a loop 31 is disposed on a second end 30 of the leash 24, wherein the loop 31 is configured to receive a hand of the user therethrough, thereby providing a gripping surface to the user. In some embodiments, the leash 24 further comprises nylon intertwined with the material of the leash 24, such that the leash 24 is strengthened thereby, producing a durable leash 24.

Referring now to FIG. 5, there is shown a perspective view of an embodiment of the animal garment in use. In one exemplary use, the user secures the animal garment about the animal by inserting the head of the animal through the front opening 13, and each front leg of the animal through one of the pair of leg openings 15. The rear side of the animal extends through the rear opening 14 such that the animal garment extends along and about the torso of the animal, thereby providing warmth and comfort to the animal. When the user desires to walk the animal, the leash 24 is removed from the interior of the pocket 20. The user can then grip the leash 24 via the loop 31 and take the animal out for a walk. When the animal must relieve itself, the U-shaped cutout 28 allows the animal to do so without soiling the animal garment. When the user desires to allow the animal freedom, the user can then fold the leash 24 and store the leash 24 within the pocket 20.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An animal garment, comprising:
a body having a front opening, a rear opening, and a pair of leg openings;
wherein the front opening is configured to receive a head of an animal therethrough, and the pair of leg openings are each configured to receive a front leg of the animal therethrough;
wherein the pair of leg openings are disposed on a lower side of the body adjacent to the front opening;
a pocket disposed on an upper side of the garment;
wherein the pocket is configured to be secured in a closed position via a fastener;
a leash affixed to the body at a first end of the leash, such that the first end is disposed within the pocket; and
wherein the leash is configured to be stored within the pocket.

2) The animal garment of claim 1, further comprising a harness disposed within the body between an inner layer of material and an outer layer of material, wherein the harness is configured to distribute force evenly across the animal.

3) The animal garment of claim 2, wherein the harness comprises a nylon cord interwoven through a front portion of the body.

4) The animal garment of claim 1, further comprising a U-shaped cutout on the lower side adjacent to the rear opening, wherein the U-shaped cutout s configured to expose an underside of the animal.

5) The animal garment of claim 1, wherein a second end of the leash comprises a loop configured to receive a hand therethrough.

6) The animal garment of claim 1, wherein the body comprises a thermally insulated material configured to retain body heat of the animal.

7) The animal garment of claim 6, wherein the insulated material comprises crocheted yarn.

8) The animal garment of claim 1, wherein the pocket further comprises a pair of lateral sides and a base, wherein the base and pair of lateral sides are affixed to the body, such that an opening is formed opposite the base.

9) The animal garment of claim 8, wherein the opening of the pocket is disposed facing the rear opening.

10) The animal garment of claim 8, wherein the opening of the pocket is disposed facing the front opening.

11) The animal garment of claim 8, wherein a slit is disposed in a sidewall of the pocket at the opening, wherein the slit is configured to receive the fastener therethrough.
